(19) United States
(12) Patent Application Publication
(10) Pub. No.: US 2003/0214962 A1
(43) Pub. Date: Nov. 20, 2003

(54) Method and apparatus for bandwidth optimization in network ring topology

(76) Inventors: Mark Allaye-Chan, Ottawa (CA); Evert De Boer, Nepean (CA); Paul Warren, Nepean (CA)

Correspondence Address: SMART & BIGGAR/FETHERSTONHAUGH, 1000 de la GAUCHETIERE WEST, SUITE 3400, MONTREAL, QC, H3B 4W5, CA

(21) Appl. No.: 10/144,842

(22) Filed: May 15, 2002

(51) Int. Cl. H04L 12/56

(52) U.S. Cl. 370/406; 370/442

(57) ABSTRACT

A 2-fibre BLSR and a 4-fibre BLSR both have a disadvantage of bandwidth inefficiencies imposed due to SONET routing constraints, which specify that each routed connection must occupy the same STS time slot throughout a given ring in the network. A direct consequence of this limitation is that it produces “stranded bandwidth” around various spans of the ring. Accordingly, a network element is provided for use in a line switched ring network. The network element is configured to enable a ring switching protection scheme in a timeslot interchange environment, to help address the stranded bandwidth inefficiencies of ring networks. The network element comprises a connection for coupling the network element to a ring transport network. When timeslot interchange has been performed by the network element on the transport network, a comparison module is accessible by the network element and adapted to confirm a nodal identity of a switch request received by the network element from other network elements on the transport network, in response to a detected network failure. A timeslot interchange module is also accessible by the network element, which is adapted to document a timeslot interchange when performed by the network element between adjacent spans of the transport network. Accordingly, the network element when addressing the detected network failure can enable the timeslot interchange, based on the confirmed nodal identity, in association with a ring bridge for bridging between working and protection timeslots.

### FIELD OF THE INVENTION

The present invention relates to optical communication systems and, in particular, to apparatus and methods for providing a protection switching scheme between network elements.

### BACKGROUND OF THE INVENTION

Optical communication systems have become widely implemented in state of the art telecommunication networks. The Synchronous Optical Network (SONET) is the standard for Synchronous Telecommunication Signals (STSs) used in optical transmission of network traffic. Typical network topologies can include a series of network elements (NEs), with each adjacent pair of NEs interconnected by a set of SONET lines (also know as a span). The SONET lines include a transmission medium with associated equipment to provide the means of transporting network traffic between adjacent NEs, one of which originates line transmissions and the other which terminates line transmissions. However, the increased carrying capacity of fibre optic lines has raised concerns about the reliability and survivability of optical networks, since a single line interruption or related NE failure can impact large amounts of network traffic. Accordingly, the implementation of protection restoration features to guard against both line and NE failures continues to be an important consideration in the design and maintenance of SONET topologies.

Line failures and NE or equipment failures are two common types of disruptions that can be experienced in a telecommunication network. Accordingly, line failures can include interruption and/or damage to the physical fibre and associated optical components a fibre cut, or line replacement during routine maintenance and upgrades. In contrast, NE or equipment failures can consist of interruptions and/or damage to the transmission or reception equipment. It should be noted that a combination of both line failures and NE failures may disable the line or span between two adjacent NEs. It is therefore an important consideration in state of the art telecommunication network systems to employ restoration techniques that temporarily restore any interrupted traffic until the detected failure is repaired. It is also recognised that restoration techniques can be employed to allow the networks to be upgraded or maintained while continuing to provide for traffic transport. One such restoration technique currently in use is line switching using the K1/K2 byte SONET protection protocol.

Unidirectional Path Switched Rings (UPSR) and Bi-direction Line Switched Rings (BLSR) are two protection schemes, which have the advantage of relatively fast speed protection software to accommodate for both line failures and NE or equipment failures. Line-switched rings use the SONET line level indications to initiate protection switching, wherein the indications can include line layer failures and Automatic Protection Switching (APS) messages that are received from other NEs. A request for switching may also be initiated via an operations interface. It is noted for 2-fibre BLSRs, APS is referred to as ring switching. For 4-fibre BLSRs, APS includes both ring switching and span switching. In a unidirectional ring, the traffic between two NEs is provisioned to travel either clockwise or counterclockwise while a bi-directional connection on a unidirectional ring uses the capacity of the entire ring. Further, if both directions of transmission use the same set of NEs and lines, then the transmission is said to be bi-directional. It is noted that a bi-directional connection on a bi-directional ring uses capacity only between the NEs where the network traffic is added and dropped. The 2-fibre and 4-fibre BLSRs are currently used in Backbone networks and are therefore built for higher data transfer rates such as OC-12/48. The main advantage of BLSR networks is that they can maximize bandwidth utilization and can provide a capacity advantage over other ring types for some traffic patterns, wherein comparatively the UPSR networks may provide less capacity given the same bandwidth. A second advantage of BLSR networks is that they operate similarly to current state of the art networks.

The 2-fibre BLSR network provides for maximum restoration (i.e., 100% restoration of restorable traffic) for single failures by reserving 50% of the ring's capacity for protection. Thus, a 2-fibre Optical Carrier level N (OC-N) ring has an effective span capacity of OC-(N2), wherein protection is provided by using a time slot selection function. The head-end line terminating equipment (LTE) performs a ring switch by bridging the working time slots in the failed direction to pre-assigned protection time slots in the direction away from the failure towards the tail-end LTE. The tail-end LTE then receives through switch selection the traffic from the protection time slots on the side away from the failure. Therefore, for the 2-fibre BLSR operating at an OC-N rate, time slot numbers 1 through N/2at the multiplex input are reserved for working channels, and time slot numbers (N/2)+1 through N at the multiplex input are reserved for protection channels. In other words, time slot number “X” of the first fibre is protected using time slot number “X +(N/2)” of the second fibre in the opposite direction, where X is an integer between 1 and (N/2). However, one disadvantage of 2-fibre BLSRs is that only ring switching can be employed in response to line and equipment failures.

The 4-fibre BLSR provides for both ring and span switching protection protocols by employing the first two fibres to carry the working channel traffic, and the second two different physical fibres to carry the protection channel traffic. Therefore, the 4-fibre BLSR operating at an OC-N rate has a span capacity of OC-N, as opposed to OC-(N/2) for the 2-fibre BLSR. Accordingly, in the 4-fibre BLSR when the failure affects only the working channels, protection can be performed similar to that of a 1:1 point-to-point system using span switching to restore traffic. Accordingly, restoration in the 4-fibre BLSR using ring switching is needed only if both the protection and the working channels on the same span are affected by the failure(s). In this case, a ring switch request bridges the working channels from the failed span to the protection channels (away from the failure) by the NEs adjacent to the failed network segment. Therefore, the provisioning for a 4-fibre BLSR is similar to that of a 2-fiber BLSR, except that all N time slots at the multiplex input are provisioned for either working or protection channels. Further, the correspondence between the protection and working channels is also simpler, whereby the time slot number “X” on the working line is protected by using time slot number “X” on the protection line. However, 4-fibre BLSRs, as well as 2-fibre, have a disadvantage of bandwidth inefficiencies imposed due to SONET BLSR routing constraints of constant channel assignment, as further detailed below.

BLSR networks have further disadvantages in that they do not provide for 1:N protection (i.e. protection of N working channels using one protection channel) since path deployment is typically designated as 50% working and 50% protection. However as BLSR does not support Timeslot Interchange (TSI), the actual efficiency of the working bandwidth can be reduced to less than the designated 50% deployment. This considerable limitation is a result of the SONET BLSR routing constraint of constant channel assignment for BLSR networks, which specifies that each routed connection must occupy the same STS time slot throughout the network. It is recognised that this constraint can be imposed through the operating software of the network, which could be used to disable any existing TSI capabilities for pass-through connections that are configurable by the network hardware. A direct consequence of this limitation is that it produces “stranded bandwidth” around various spans of the ring. For example, if only time slot STS#2 was available on span A-B between adjacent LTEs but time slot STS#1 was available on the span B-C, then a required STS#1 connection could not be routed via the connection path A-B-C. Therefore, the available time slot STS#1 on the span B-C would be considered as stranded bandwidth for the required connection. This bandwidth inefficiency contributes to the network-wide reduction in actual usage of the designated ring capacity.

A further disadvantage related to stranded bandwidth is routing inefficiencies of concatenated payloads. Another SONET BLSR routing constraint is that an STS-Nc concatenated payload must occupy a contiguous bandwidth range on any given ring span. Therefore, a payload STS-3c occupying time slots STS#1,2,3 on the span A-B must also occupy the same time slots on the adjacent span B-C, which creates a localised bandwidth inefficiency problem in ring networks for multiple hop concatenated payloads.

A still further disadvantage of BLSR networks is that all LTEs around the ring network must have the same port capacity. Accordingly, each adjacent LTE sharing a particular span must have the same size working/protection ports to meet traffic requirements across the span. This commonality of port sizes around a given ring network is irrespective of the actual bandwidth demands on various spans. This same-size limitation results in the overall bandwidth capacity must be designed for all ring spans, so as to accommodate the one span with the greatest traffic demands, which can produce ring networks with over-designed and under-utilised spans contributing to bandwidth wastage.

Accordingly, it is an object of the present invention to provide a protection signalling scheme to obviate or mitigate at least some of the above presented disadvantages.

### SUMMARY OF THE INVENTION

A 2-fibre BLSR network provides for maximum restoration (i.e., 100% restoration of restorable traffic) for single failures by reserving 50% of the ring's capacity for protection. Thus, a 2-fibre Optical Carrier level N (OC-N) ring has an effective span capacity of OC-(N/2), wherein protection is provided by using a time slot selection function. A 4-fibre BLSR provides for both ring and span switching protection protocols by employing the first two fibres to carry the working channel traffic, and the second two different physical fibres to carry the protection channel traffic. However, 4-fibre BLSR has a disadvantage of bandwidth inefficiencies imposed due to SONET routing constraints, which specify that each routed connection must occupy the same STS time slot throughout the network. It is recognised that this constraint can be imposed through the operating software of the network, which could be used to disable any existing TSI pass through connection capabilities of the network hardware. A direct consequence of this limitation is that it produces “stranded bandwidth” around various spans of the ring.

Accordingly, the present invention provides a network element for use in a line switched ring network. The network element is configured to enable a ring switching protection scheme in a timeslot interchange environment, to help address the stranded bandwidth inefficiencies of ring networks. The network element comprises a link for coupling the network element to a ring transport network. When timeslot interchange has been performed by the network element on the transport network, a confirmation module is accessible by the network element and adapted to confirm a nodal or APS identity of a switch request received by the network element from other network elements on the transport network, in response to a detected network failure. A timeslot interchange module is also accessible by the network element, which is adapted to document a timeslot interchange when performed by the network element between adjacent spans of the transport network. Accordingly, the network element when addressing the detected network failure can enable the timeslot interchange, based on the confirmed nodal identity, in association with a ring bridge for bridging between working and protection timeslots.

According to the present invention there is provided a network element, in a line switched ring network, for providing a ring switching protection scheme in a timeslot interchange environment. The network element comprises a link for connecting the network element to a transport network. A confirmation module is accessible by the network element, the confirmation module adapted to confirm a nodal identity of a switch request receivable by the network element from other network elements on the transport network. A timeslot interchange module is accessible by the network element, the interchange module adapted to document a timeslot interchange when performed by the network element between adjacent spans of the transport network. Accordingly, the network element is adapted to enable the timeslot interchange, based on the confirmed nodal identity, in association with a ring bridge for bridging between working and protection timeslots in the event of a network failure.

According to a further aspect of the present invention there is provided a computer program product, for use in a line switched ring network, for providing a ring switching protection scheme in a timeslot interchange environment. The product comprises a computer readable medium, and a link module stored on the computer readable medium for connecting the network element to a transport network. A confirmation module is coupled to the link module, the confirmation module accessible by a network element, the confirmation module confirming a nodal identity of a switch request when received by the network element from other network elements on a transport network. A time slot interchange module is coupled to the confirmation module, the interchange module accessible by the network element, the interchange module for documenting a time slot interchange when performed by the network element between adjacent spans of the transport network. Accordingly, the computer program product enables the timeslot interchange, based on the confirmed nodal identity, in association with a ring bridge performed by the network element for bridging between working and protection timeslots in the event of a network failure.

### BRIEF DESCRIPTION OF THE DRAWINGS

These and other features of the preferred embodiments of the invention will become more apparent in the following detailed description in which reference is made to the appended drawings wherein:

FIG. 1 is a diagram of a transport network;

FIG. 2 shows a ring topology of the network of FIG. 1;

FIG. 3a shows an example connection configuration for the network of FIG. 1;

FIG. 3b shows a failure mode of the network of FIG. 3a;

FIG. 3c shows a counter clockwise transmission of traffic for the network failure of FIG. 3b;

FIGS. 3d 3c shows a clockwise transmission of traffic for the network failure of FIG. 3b;

FIG. 4 is a flowchart of the protection switching scheme of FIG. 3c;

FIG. 5 is a further embodiment of the network of FIG. 1;

FIG. 6a shows an example connection configuration for the network of FIG. 5;

FIG. 6b shows a failure mode of the network of FIG. 6a;

FIG. 6c shows a protection bridge of the failure of FIG. 6b;

FIG. 7 is a flowchart of the protection switching scheme of FIG. 6c;

FIG. 8a is a further embodiment of FIG. 6a;

FIG. 8b is a further embodiment of FIG. 6b;

FIG. 8c is a further embodiment of FIG. 6c; and

FIG. 9 is a flowchart of the protection switching scheme of FIG. 8c.

### DESCRIPTION OF THE PREFERRED EMBODIMENTS

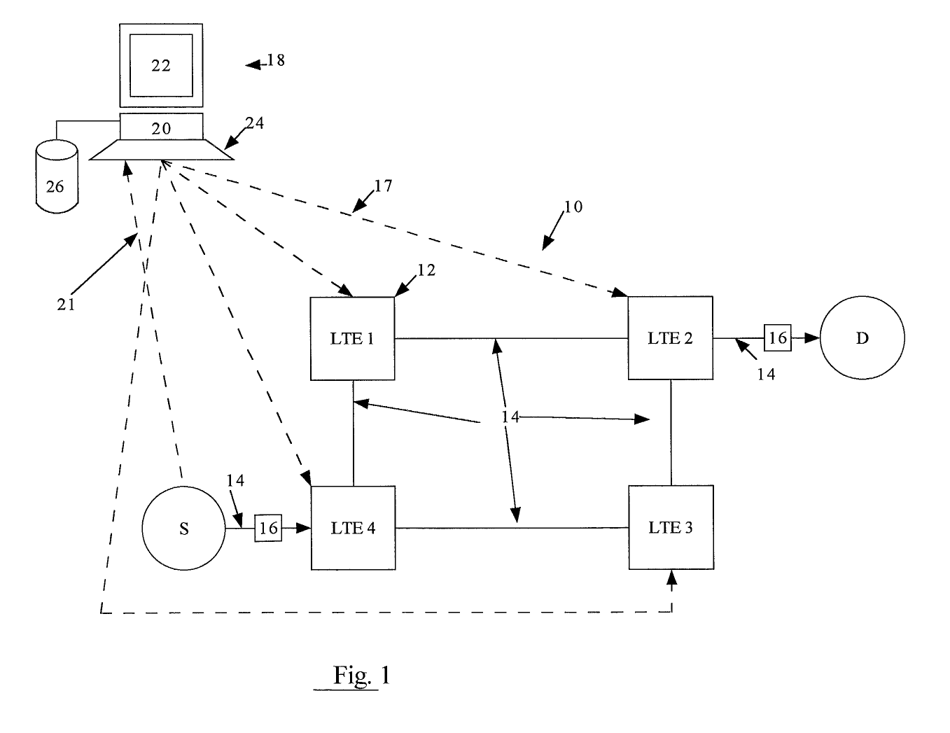

Referring to FIG. 1, an optical transport network 10 contains a series of network elements or line terminating equipment 12 (such as LTEs 1,2,3,4) interconnected by bulk data transmission mediums 14 to form a closed loop ring architecture. These mediums 14 can consist of, such as but not limited to, optical fibres and transmission equipment such as amplification and regenerator modules. It is further recognised that these mediums 14 can also consist of DSL (Digital Subscriber Loop), cable, and wireless mediums, wherein each medium 14 is capable of providing for the transmission of multiple wavelengths as required by the transport network 10. The transmission structure of the transport network 10 can be used by a variety of different carriers, such as ILECs, CLECs, ISPs, and other large enterprises to monitor and transmit a diverse mixture of network traffic 16 in various formats. These formats can include voice, video, and data content transferred over the individual SONET, SDH, IP, WDN, ATM, and Ethernet networks associated with the transport network 10.

In operation of general SONET networks, payloads representing the network traffic 16 are converted into a standard optical format called the Synchronous Transport Signal (STS), which is the basic building block of a SONET optical interface. The STS-1 (level 1) is the basic signal rate of SONET and multiple STS-1 frames may be concatenated to form STS-Nc payloads, where the multiple STS-1 frames are byte interleaved. Accordingly, a single optical channel operates and transmits the network traffic 16 according to high speed synchronous digital hierarchy (SDH) standards, such as the SONET OC-3, OC-12, and OC-48 rate protocols. The introduction of the network traffic 16 is done by a source element S onto the transport network 10, which transports the traffic 16 to a destination element D. For bi-directional communications the source S and destination D elements can reverse roles, depending upon the direction of transmission of the network traffic 16 over the transport network 10. It is recognised that the source S and destination D elements can represent individual carriers, or interconnections with other adjacent networks such as through matching nodes. It is further recognised that the elements S, D can include such as but not limited to hubs, leased lines, TDM, PBX, and Framed Relay PVC. Further, the transport network 10 type can also include SDH formats, such as but not limited to frame and port formats.

Referring again to FIG. 1, operation of each LTE 12 can be monitored with control signals 17 by a central integrated management or Operations Support System (OSS), referred to by arrow 18, which can co-ordinate a plurality of traffic connection requests 21 received from the source S element. The support system 18 can include a processor 20. The processor 20 is coupled to a display 22 and to user input devices 24, such as a keyboard, mouse, or other suitable devices. If the display 22 is touch sensitive, then the display 22 itself can be employed as the user input device 24. A computer readable storage medium 26 is coupled to the processor 20 for providing instructions to the processor 20 to instruct and/or configure the various LTEs 12 to perform steps or algorithms related to the operation of ring protection switching implemented on the transport network 10, as further explained below. The computer readable medium 26 can include hardware and/or software such as, by way of example only, magnetic disks, magnetic tape, optically readable medium such as CD ROM's, and semi-conductor memory such as PCMCIA cards. In each case, the medium 26 may take the form of a portable item such as a small disk, floppy diskette, cassette, or it may take the form of a relatively large or immobile item such as hard disk drive, solid state memory card, or RAM provided in the support system 18. It should be noted that the above listed example mediums 26 can be used either alone or in combination. Accordingly, the ring switching protection scheme, as further defined below, can be implemented on the transport network 10 in regard to the co-ordination of the plurality of connection requests 21 submitted by the source element S, as well as monitoring the timely transmission of the network traffic 16, in the event of transport network 10 failure.

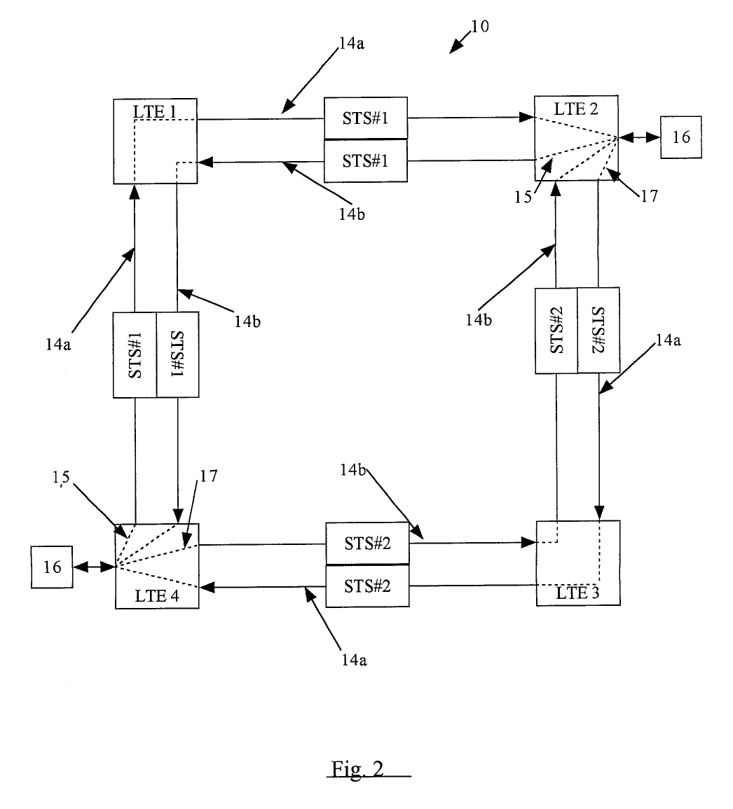

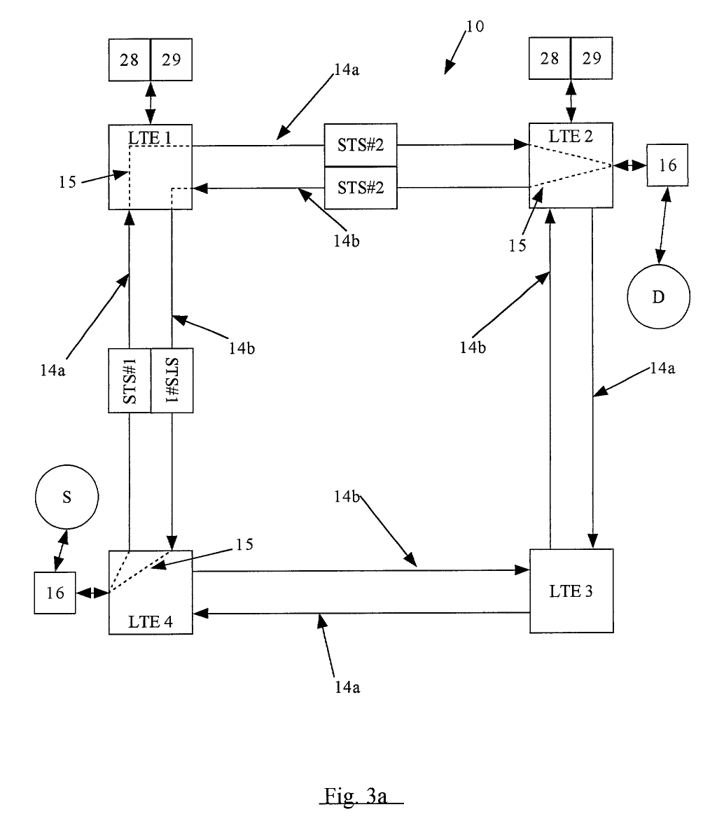

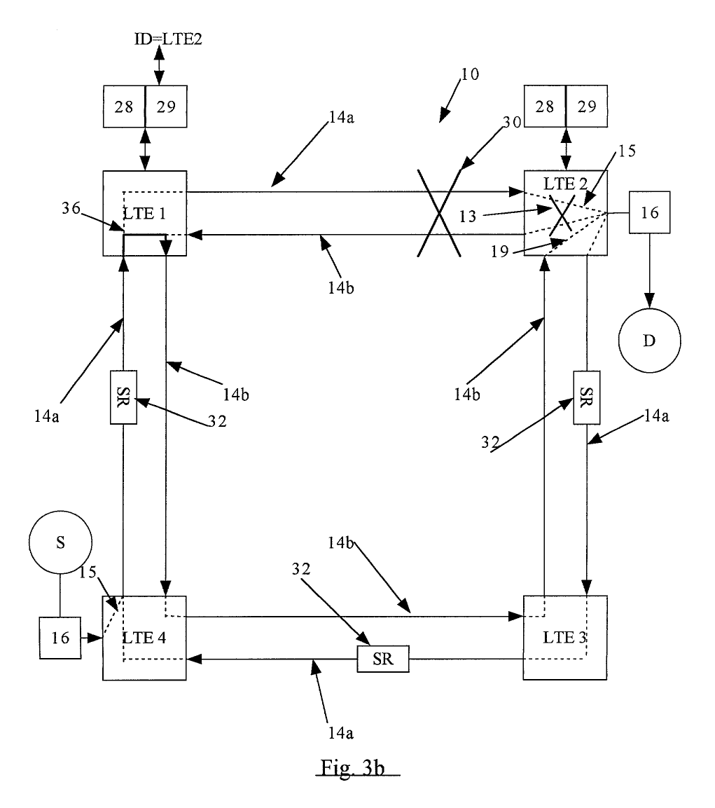

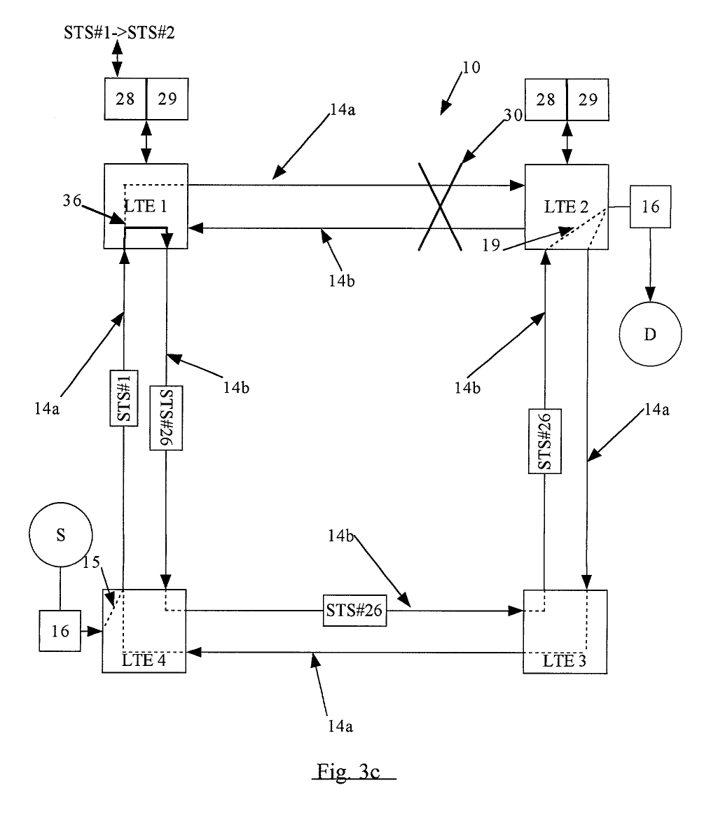

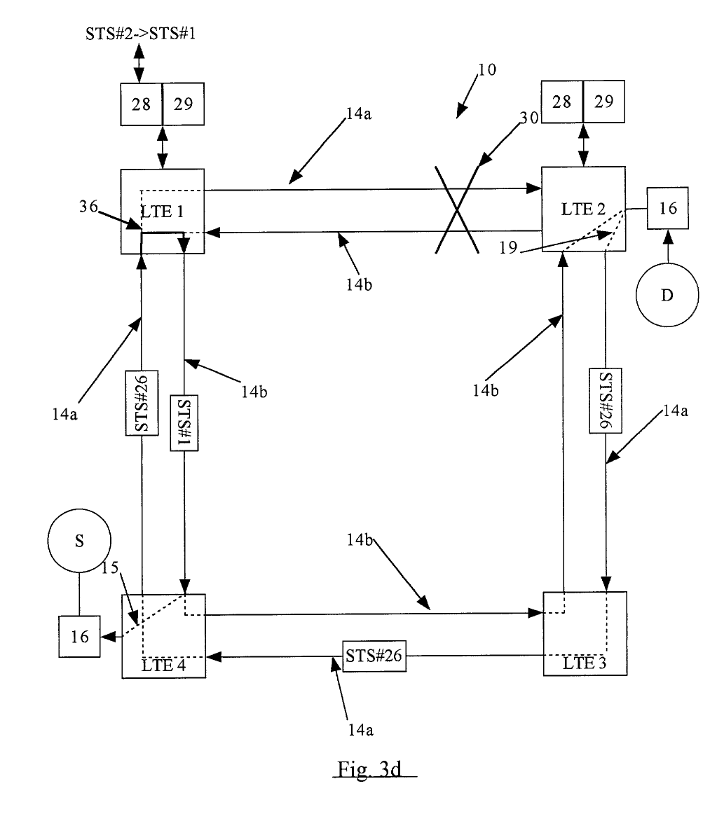

Referring to FIG. 2, an example 2-fibre Bi-direction Line Switched Ring (BLSR), representing the transport network 10, contains a set of line terminating equipment (LTEi) LTE1, LTE2, LTE3, LTE4 interconnected by pairs of adjacent transmission mediums or lines 14, identified as 14a and 14b. The lines 14a provide a working/protection channel for the traffic 16 in the clockwise direction, and the lines 14b a working/protection channel in the counter-clockwise direction. The selected network elements LTEi, lines 14a,b, and timeslots STS-N are determined by the management system 18 (see FIG. 1) when the traffic connection request 21 is set-up. Therefore, for example, the traffic 16 can be transported by an available timeslot STS#1 in a clockwise direction along the path 4-1-2 (represented by LTE4, LTE1, LTE2), comprising individual lines 4-3 and 3-2 and LTE internal routing 15, or by an available timeslot STS#2 in a counter-clockwise direction along the path 4-3-2, comprising individual connections 4-1 and 1-2 and LTE internal routing 17. The internal routings 15 can represent the pass-through internal configurations of the various LTEi to facilitate the communication of the traffic 16 around the transport network 10. It is noted that the timeslot STS#1 could also be used along the path 4-3-2, if available. However, it is also noted that typical BLSR networks must use the same timeslots for transmission of the traffic 16 along the selected path between source S and destination D elements, in this example LTE4 to LTE2. This SONET routing constraint of same timeslot assignment is removed (see FIG. 3a) for purposes of the present ring switching protection scheme, as further detailed below.

Ring switching protection signaling in the transport network 10 is initiated based on line level conditions detected by the affected LTEi, such as but not limited to Signal Failure (SF) due to Loss Of Signal (LOS), Loss of Frame (LOF), line AIS, when BIP-8 errors reach saturation, and/or when a Signal Degrade (SD) is declared in response to exceeding Line BIP-8 error rates. These conditions are applicable for both uni- and bi-directional failures. Other conditions that can initiate ring switching protection signaling are such as but not limited to forced/manual switches for transport network 10 maintenance, lockouts, protection exerciser bridges, and extra traffic requests for utilisation of idle protection channels.

Accordingly, when protection switching conditions are detected in the transport network 10, the adjacent LTEi insert the appropriate K1 and K2 byte indications into the SONET line overhead on the lines 14a,b in order to transport the required protection switch requests to the affected LTEi. For the 2-fibre ring transport network 10 of FIG. 2, protection is provided by reserving some of the bandwidth on lines 14a,b because neither lines 14a or 14b are only dedicated for protection. Protection switching in BLSR is performed by using a form of predetermined timeslot selection, where each working timeslot on lines 14a is pre-assigned (not user-settable) using the BLSR switching protocols to a protection timeslot on lines 14b travelling in the opposite direction. To provide the maximum restoration (i.e., 100% restoration of restorable traffic 16) for single failures, it is necessary to reserve 50% of the lines 14a,b bandwidth capacity for protection. Thus, a 2-fiber Optical Carrier level 48 (OC-48) effectively has the line 14a,b capacity of OC-24. Using the OC-48 example, STS numbers 1 through 24 at a multiplex input of the LTEi are reserved for working timeslots, whereas STS numbers 25 through 48 at the multiplex input of the LTEi are reserved for protection timeslots. Therefore, working timeslot STS#1 of the first lines 14a is protected using protection timeslot STS#25 of the second lines 14b travelling in the opposite direction. It is recognized that other OC-N port sizes can be used over the transport network 10, if desired.

Referring to FIG. 3a, the connection request 21 (see FIG. 1) for transporting traffic 16, from element S to element D, has resulted in the support system 18 (see FIG. 1) selecting the path 4-1-2 on lines 14a,b and internal routing 15 of the corresponding LTEi. It should be noted that removing the SONET BLSR constraint of same timeslot assignment has allowed the set-up of available working timeslot STS#1 on connection 4-1 and a different working timeslot STS#2 on connection 1-2, now selectable by the support system 18 or the respective LTEi. This timeslot selection can be implemented through a timeslot interchange (TSI) module 28, which is locally accessible in the transport network 10 by the LTEi, to keep track of timeslot interchanges local to affected LTEi. Accordingly, the interchange module 28 accessible by LTE1 has recorded that STS#1 for connection 4-1 is cross-connected onto STS#2 for connection 1-2. It is recognised that each LTEi can have local access, in the transport network 10, to the interchange module 28 for monitoring the local timeslot interchanges. It is also recognised that multiple interchange modules 28 can be employed, so as to provide direct local access to each of the LTEi.

In a simplified bi-directional view of BLSR transport networks 10, the LTEi follow maps (not shown) as is known in the art to facilitate the setup of the paths and subsequent transmission and reception of the traffic 16. These maps are used for each BLSR ring group that is part of the complete transport network 10. One map used by the respective LTEi pertains to the Idle State, which indicates all traffic 16 that is on the working timeslots. A second map pertains to Full Pass Through, which describes all protection timeslots that are mapped one to one, i.e. protection timeslots STS#25-48 incoming from the west direction of the LTEi (for traditional network layouts of west to east orientation) are mapped to corresponding protection timeslots STS#25-48 east bound from the LTEi and vise versa. A third map contains all east span switches (applicable to 4-fibre BLSR only), wherein east bound working traffic 16 is represented when switched onto the east bound protection traffic 16. A fourth map contains all west span switches (applicable to 4-fibre BLSR only), wherein west bound working traffic 16 is represented when switched onto the west bound protection traffic 16. A fifth map is for east+west span switches (applicable to 4-fibre BLSR only), wherein both east and west working timeslots to protection timeslots are simultaneously switched. A sixth map is for west ring switches, wherein westbound working traffic 16 is bridged onto the eastbound protection traffic 16. Further, traffic 16 from the east protection is selected to replace traffic normally received on the working timeslots from the west. A seventh map is for east ring switches (applicable to both 2-fibre and 4-fibre BLSR), wherein eastbound working traffic 16 is bridged onto the westbound protection timeslots. Further, traffic 16 from the west protection timeslots is selected to replace traffic 16 normally received on the working timeslots from the east. In addition to all traffic routing maps, additional squelch maps are also included to help support the pass-through TSI capability on the transport network 10. As such, all maps shown above, with the exception of the TSI modules 28 are what exist with today's BLSR maps to implement the physical cross connections used to route the traffic 16 through the various LTEi and around the transport network 10.

It is recognized that the above-described interchange module 28 is show as external to the LTEi. It is envisioned in implementation of the BLSR pass-through TSI, that all the traffic 16 flows through the connections present in the TSI module 28. Further, the TSI module 28 could also be the means by which the individual bridges and switches are implemented, as further described below. The H/W fabric, not shown, traditionally provides the physical connections for the incoming and outgoing time slots. Therefore, it is recognised that the above described TSI modules 28 could also incorporate the actual H/W switch fabric through which the traffic 16 flows.

It is proposed in one embodiment of the present switching protection scheme that the additional ring switch maps 28 are used in the receive direction to help represent TSI manipulations which may occur at the various points in the working pass-though LTEi. Accordingly, the receive direction in the present context relates to the traffic 16 received by a ring switching LTEi adjacent to the failure. One envisioned abstraction is that the bridge map or transmit map is separated from the receive traffic select (or switch map), represented by TSI modules 28. Accordingly, the number of additional maps 28 depend on the number of different scenarios that the BLSR transport networks 10 are designed to accommodate. In such case as where the transport network 10 must accommodate one LTEi failure or isolated LTEi to both the East and West of the LTEi in question, in addition a single link failure, then two additional receive direction selection or switch maps (TSI modules 28) would be used. If for example, both single and double missing LTEi failures occur on either side of a respective LTEi, then four TSI modules 28 would be used in addition to the usual map set (one to seven) furnished with standard BLSR. Furthermore, it is recognized that these TSI modules 28 can be held in the LTEi or downloaded by the respective OCCi at the onset of failure. Naturally, for performance reasons, it may be advantageous to pre-download the TSI modules 28 from the OCCi in coordination with the OCCi during setup and tear down of the required paths for the traffic 16 as requested by the support system 18.

Referring again to FIG. 3a, it is noted that dissimilar timeslots were selected by the support system 18, using the TSI modules 28, so as to help use otherwise stranded bandwidth, where STS#1 on connection 1-2 was unavailable to transport traffic 16 on working timeslots STS#1-STS#24 from element S to element D. Therefore, the connection request 21 is represented in the transport network 10 by path 4-1-2 (STS#1/STS#2), in what can be referred to as the working path. Accordingly, in the event of a local line/nodal failure on path 4-1-2, the traffic 16 normally received by LTE2 from LTE1 on working timeslot STS#2 would now be expected to be received by LTE2 from LTE3 on protection timeslot STS#26, which is a consequence of allowing pass-through TSI on the transport network 10 at LTE 1. It should be noted that this is contrary to the expected protection timeslot STS#25 by LTE4, since the traffic 16 originated on working timeslot STS#1. Further, it is recognized that bridging and switch selection of working timeslots onto protection timeslots is irrespective as to whether the traffic 16 is present on the transport network 10.

Referring to FIG. 3b, a single line failure 30 on lines 14a,b interconnecting LTE1 to LTE2 is shown, where for exemplary purposes only, LTE1 is considered the head-end and LTE2 the tail-end line terminating equipment, in the case where any traffic 16 would be transmitted in the direction from the source element S to the destination element D. After the LOS failure 30 has been detected by LTE2, LTE2 becomes the switching node according to standard BLSR protocols. The tail-end LTE2 sends a ring switch request 32 to the head-end LTE1 by passing the required K bytes through LTE3 and LTE4 along the path 2-3-4-1 on lines 14b, as well as waits to determine whether it will select from its internal routing 15 or the protection switch selection 19. This selection from routing 15 to switch 19 is indicated by the “X” referenced by numeral 13. LTE1 executes a ring bridge 36 to redirect any traffic 16 away from the failed line 1-2. LTE1 is now setup to send all incoming traffic 16 originally destined out from LTE1 to LTE2 on the working timeslots STS#1-24 of lines 14a to the protection timeslots STS#25-48 of lines14b, which are directed on the path 1-4-3-2 away from the failure 30 towards the tail-end LTE2. It should be noted that LTE1 can still maintain the pass-through TSI for incoming traffic 16, for example on the working timeslot STS#1 from LTE4, by interchanging STS#1 received from LTE1 onto STS#2 transmitted to LTE2, and then ring switching STS#2 onto the protection timeslot STS#26 through the bridge 36 (see FIG. 3c). It is also recognized that the head-end LTE1 will continue to send the incoming traffic 16 out on the working timeslots STS#1-24 as well, wherein the tail-end LTE2 will choose to receive the traffic 16 by switch selecting either the working or protection timeslots. In this case, the LTE2 has chosen a switch selection 19 to receive off of the protection timeslots on the path 4-1-4-3-2. Further, both LTE3 and LTE4 enter bi-directional full pass-through mode to accommodate the transmission of the switch request 32, as well as the transmission of the traffic 16 on the path 4-1-4-3-2. It should be noted that TS1 is commonly available at the ingress/egress (entry/exit) points of the transport network 10, which is distinct from the implemented TSI in the pass-through connections of the LTEi. The switch selections 19 represent the reconfiguration of the various affected LTEi so as to choose the 24 traffic 16 from either the working or protection timeslots.

When LTE1 receives the switch request 32, LTE1 notes that LTE2 intends the switch selection 19 and LTE2 now knows to receive any old traffic 16, previously on working timeslot STS#2 for line 1-2, through the switch selection 19 from the protection timeslot STS#26. Similarly, all other working timeslots STS#1-24 are selected by LTE2 from corresponding protection timeslots STS#25-48. It should be noted that the failure 30 is confirmed by LTE1 as a single line failure by checking the originating APS ID of the switch request 32, such that ID=LTE2. An APS ID comparison module 29 can be used to implement this APS ID check in order to confirm the matching of the APS ID. In the event a match is obtained, the head-end node LTE1 confirms that the detected failure 30 affects only the single line (in the present example lines 14a,b on span 1-2) and the TSI information of LTE1 is still current for transmission of the traffic 16 over the protection path 4-1-4-3-2 towards LTE2, i.e. LTE2 expects the traffic 16 on protection timeslot STS#26, rather than STS#25. It is recognised that the modules 28, 29 can be resident on the respective LTEi, and/or remotely accessible by the LTEi through logical connections.

It is recognized that the BLSR transport network 10 of FIG. 3b will also implement similar bridges 36 and switch selections 19 in the case where the LTE2 operates as the head-end equipment and the LTE1 operates as the tail-end equipment, such as to accommodate failures 30 occuring on line 14b between LTE1 and LTE2. In this case, LTE1 will initiate the switch request 32 along the path 1-4-3-2 to LTE2, LTE2 would execute the ring bridge 36 and check the APS ID such that ID=LTE2, and LTE1 would implement the switch selection 19. It is also recognized that both LTE1 and LTE 2 can simultaneously operate as both the tail end and head end, in such case as where both directions represented by lines14a and 14b between LTE1 and LTE2 are failed.

Referring to FIG. 3c for demonstrating the transmission of traffic 16 from the source element S, in initiating the ring bridge 36, it should be noted that LTE1 uses the TSI information (accessible through interchange module 28) to maintain the interchange of the working timeslot STS#1 received from LTE4 through the working timeslot STS#2, which is placed onto the protection timeslot STS#26 transmitted by LTE1 by the bridge 36, so as to account for the protection timeslot expectations of LTE2. It should be remembered that the original traffic 16, interrupted by the failure 30, was being transmitted to LTE2 on working timeslot STS#2 on the line 1-2. It is recognised that LTE4 and LTE3 can access the interchange module 28 to further optimise bandwidth usage on the path 1-4-3-2 using timeslot interchange. Accordingly, the ring bridged transport network 10 of FIG. 3c has reached a steady state. Therefore, the traffic 16 is now directed from source element S onto the transport network 10, which then transmits the traffic 16 along line 4-1 on the working timeslot STS#1 transmitted from LTE4, then timeslot interchanged onto the working timeslot STS#2, then ring bridged along the path 1-4-3-2 on the protection timeslot STS#26, and then off the transport network 10 by switch selection 15 to destination element D. It is recognised that the interchange and bridge operation can occur simultaneously.

Referring to FIG. 3d for demonstrating the transmission of traffic 16 from the destination element D, which can coexist with the traffic 16 pattern (from source element D) shown in FIG. 3c. The traffic 16 of FIG. 3d is now selected by switch selection 19 onto the protection timeslot STS#26 transmitted by LTE2, as the failure 30 remains. Accordingly, the traffic 16 is transmitted around the transport network 10 on line 14a on STS#26 through LTE3 and LTE4 to be received by LTE1, along the path 2-3-4-1. At this point, LTE1 uses the bridge 36 to switch the protection timeslot STS#26 onto the working timeslot STS#2. The LTE1 then uses TSI, as recorded by the interchange module 28, to maintain the interchange of the working timeslot STS#2 onto the working timeslot STS#1, thereby accommodating the timeslot expectations of LTE4 to switch the traffic 16 through internal routing 15 being received from LTE1 on STS#1, and then off the transport network 10 to the source element S. It should be recognized that the original traffic 16 was transmitted by LTE4 onto the working timeslot STS#1, which therefore results in LTE4 expecting to switch the traffic 16 from the working timeslot STS#1, received from LTE1 on the line 1-4. It is also recognized that LTE4 could access the interchange module 28 so as to reconfigure the ports of LTE4 to select received traffic 16 directly from the protection timeslot STS#26, if desired. Accordingly, the use of TSI on the BLSR transport network 10 of FIGS. 3c and 3d does not have to affect the standard timeslot offset executed by the bridge 36, i.e. bridging working timeslots STS#1-24 onto corresponding protection timeslots STS#25-48. Preferably, TSI in the present transport network 10 is implemented only for the working timeslots STS#1-24, however, it is recognized that other bridging/selection schemes could be devised to implement TSI for the standard timeslot offset, if desired.

Once the line failure 30 is corrected and the adjacent LTEi are notified, the ring bridge 36 placing the working timeslots STS#1-24 on to the protection timeslots STS#25-48 is removed utilizing appropriate BLSR protocols (such as first removing the tail end switch selection 19 following a wait to restore period), and then the traffic 16 resumes transmission along path 4-1-2 as per the traffic 16 pattern shown in FIG. 3a. The interchange module 28 is updated to reflect the resume to idle state, wherein the line 4-1 now operates on working timeslot STS#1 and line 1-2 operates on working connection STS#2. It is recognised that working timeslots other than the original STS#1/STS#2 configuration could be utilized on the path 4-1-2, if desired, once the line failure 30 has been corrected.

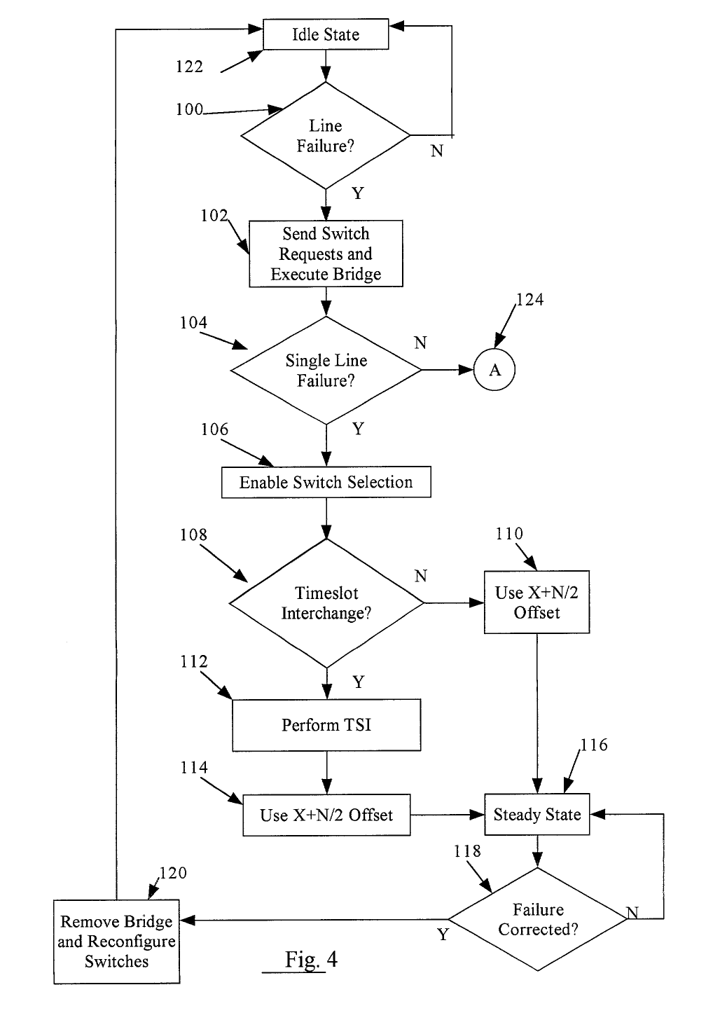

Accordingly, in reference to FIG. 4, an example operation of the ring switch procedure for the transport network of FIGS. 3a,b,c begins when the line failure 30 is detected at step 100. Then, the adjacent tail-end LTE2 sends 102 the switch request 32 to the head-end LTE1 and LTE1executes the bridge 36 (see FIG. 3b). If LTE1 receives the corresponding switch request 32 destined for LTE1 from its neighbour adjacent to the failure 30 (LTE1 receives ring switch request 32 from LTE2, ID=LTE2), then the failure 30 is confirmed 104 as a single line failure and the corresponding switch selection 19 is confirmed 106 at the tail-end LTE2. Next, the TSI is checked 108 to see if it was implemented by any of the associated LTEi, as recorded in the interchange module 28. If not, then the working to protection bridge 36 makes available 110 all working timeslots STS#1-24 to their corresponding protection timeslots STS#25-48, as per the standard BLSR timeslot offset of “X+(N/2)” for 2-fibre networks.

However, in the present example, a TSI was performed by the LTE1 prior to detection of the failure 30, namely the working timeslot STS#1 received by LTE4 on line 4-1 was redirected onto the working timeslot STS#2 transmitted by LTE1 on line 1-2 (see FIG. 3a). Therefore, LTE1 monitors 112 the TSI condition as recorded in the interchange module 28 to continue placing the working timeslot STS#1 on to the working timeslot STS#2, prior to the use 114 of the timeslot offset of “X+(N/2)” through the bridge 36 to place the working timeslot STS#2 onto the protection timeslot STS#26, as transmitted by LTE1 (as expected by LTE2). The transport network 10 then operates in a steady state at step 116 (see FIG. 3c). Once the failure 30 is corrected at step 118, the working to protection bridge 36 is removed, the switch selections 19 reconfigured 120 according to BLSR protocols to return to the original internal routing 15, and the traffic 16 then resumes its transmission along the original path 4-1-2 between source element S and destination element D (see FIG. 3a) on the working timeslots STS#1-24 only, thereby returning the transport network 10 to its idle state at step 122. It is recognised that the interchange module 28 can be accessed by the LTE1 prior to ring bridge 36 removal, so as to confirm that the working timeslot STS#1 received by LTE4 should be placed back onto the working timeslot STS#2 transmitted by LTE1 for the line 1-2. It is further recognized that a similar respective operation of the transport network 10, in response to the failure 30, could be implemented in the case of LTE2 operating as the head-end and LTE1 operating as the tail-end, see FIG. 3d.

It is noted that the above ring switching protection scheme is directed to the single line failure 30 mode, and is preferably performed at the transport network 10 level. In the event of ring segmentation and/or LTEi failure detection, which implies an effective multiple line failure mode, the above single line scheme is not used by the LTEi in the transport network 10. This is because in the present example the TSI information in the interchange module 28 of LTE1 may not correctly represent the protection timeslot STS#s expected by LTE2, from which to select the traffic 16, since other LTEi (in the case of additional LTEi between LTE1 and LTE2—not shown) may also have implemented their own timeslot interchanges. Therefore, the occurrence of LTEi and/or ring segmentation failures are disallowed in implementation of the above-described ring switching protection scheme for single line failures 30, which are ring switched preferably at the transport network 10 level. This distinction is referenced at step 124 in FIG. 4. It should be noted that the single line failure refers to the complete failure of communication on both the protection and working timeslots between adjacent LTEi. This is distinct from a span failure on 4-fibre BLSR networks, not shown, wherein only a portion of the communication between adjacent LTEi (working or protection) may fail. This partial failure can be referred to as a span failure, which is correctable through span switching.

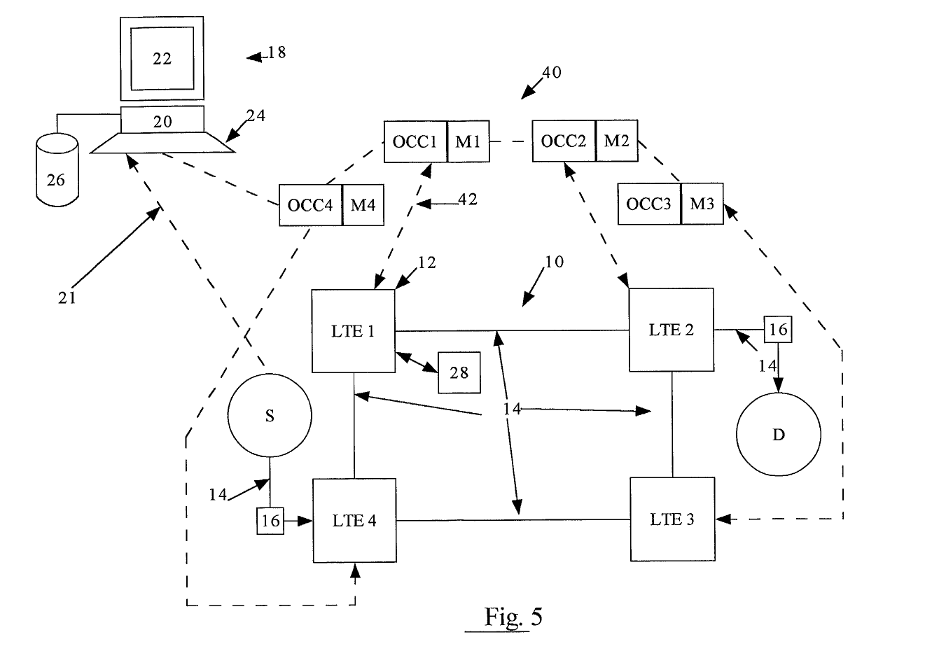

A further embodiment is shown in FIG. 5, wherein the transport network 10 is monitored by a control plane 40, which consists of a series of distributed Optical Connection Controllers (OCCi) OCC1, OCC2, OCC3, OCC4 coupled to each LTEi by control links 42. The controllers OCCi co-ordinate the connection requests 21 from the support system 18 to each of their corresponding LTEi, so as to set up the corresponding paths and timeslots for the network traffic 16 using the LTEi in the transport network 10. It is recognised that the connection request 21 with the ASON control plane 40 can come directly from the port interfaces with the client networks (for example elements S and D) connected to the transport network 10. Accordingly, this association of OCCi operates as a control plane 40, so as to automatically set up and monitor the complete picture of their corresponding LTEi interconnections across the transport network 10. The distributed OCCi in conjunction with the support system 18 help to keep track of the port status (up/down) of the various LTEi, and whether switch requests have been completed in path set-up and maintenance.

Each controller OCCi of the control plane 40 stores a corresponding map (Mn) M1, M2, M3, M4 of all LTEi used in the various paths of the transport network 10 for carrying the network traffic 16. These maps Mn identify the particular working timeslots STS#1-24 available on the corresponding connections between the LTEi, as well as the available related protection timeslots STS#25-48. This knowledge of working/protection timeslot utilisation by the OCCi can be particularly beneficial in the present transport network 10 environment, where timeslot interchange is permitted. The OCCi can also co-ordinate the available bandwidth in the paths of the transport network 10, so as to help optimise timeslot usage through timeslot interchange protocols as described above with reference to FIG. 3a. Accordingly, the OCCi also have access to the timeslot interchange modules 28 so that they can update their respective overview of the connection architecture of the transport network 10, as their respective LTEi effect the transport of the traffic 16 over the selected paths. Therefore, the OCCi could be used to update the timeslot interchange modules 28 of respective LTEi to account for the potential multiple timeslot interchanges that are requested along the selected paths of the transport network 10. This cross-connect information would then be accessible at the transport network 10 level, for utilisation in the event of multiple line failure mode detection.

Therefore, the OCCi maintain in their maps Mn information on the protection architecture as an overview of the transport network 10, explicit information of the bandwidth availability for each timeslot STS# on respective network connections between LTEi, and information on equipment diversity. This Mn information can also be used to help optimise bandwidth usage for concatenated payloads. The OCCi in the control plane 40 can communicate with one another to take over the co-ordination of interconnections between the LTEi in situations when warranted. However, it is recognised that protection switching times are typically most optimised when switching is performed soley in the transport network 10, by direct insertion of the appropriate K1 and K2 byte indications into the SONET line overhead by the LTEi. Therefore, it is assumed that any interaction between the transport network 10 and the control plane 40 can increase protection switching times during switching, as compared to switching coordinated solely by the LTEi in the transport network 10.

However, in situations where timeslot interchanges have been performed by the LTEi in the transport network 10, the OCCi can coordinate protection switch requests across the control plane 40 in the event of multiple line failure modes. It should be noted that the existence of this failure mode would be confirmed by the affected LTEi using the comparison module 29 to process the switch request 32. It is also recognized that the OCCi could detect this mismatch of APS IDs when monitoring the status of the transport network 10.

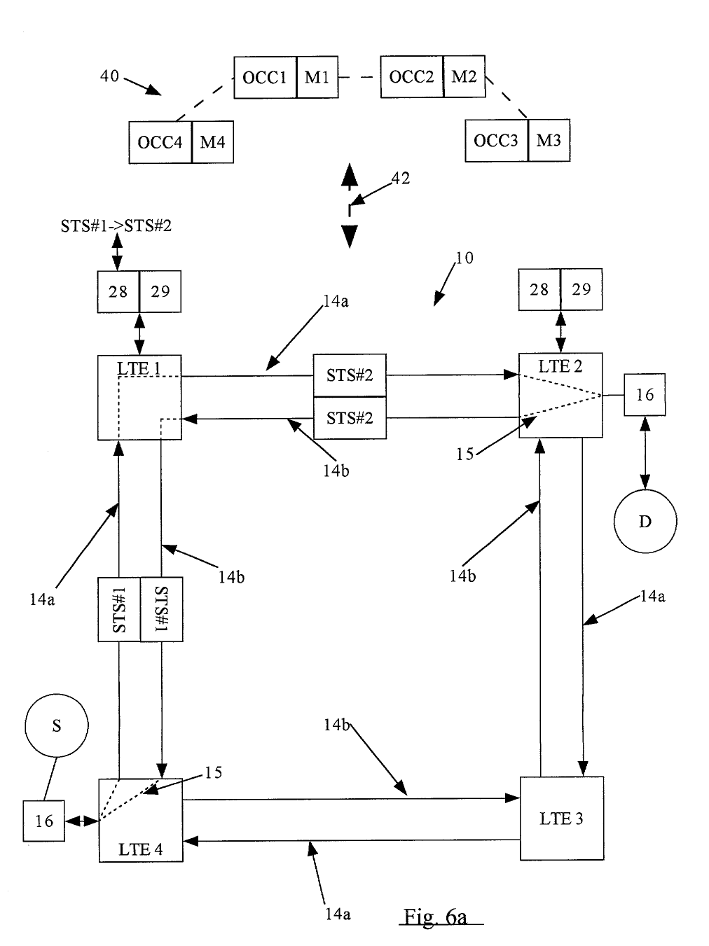

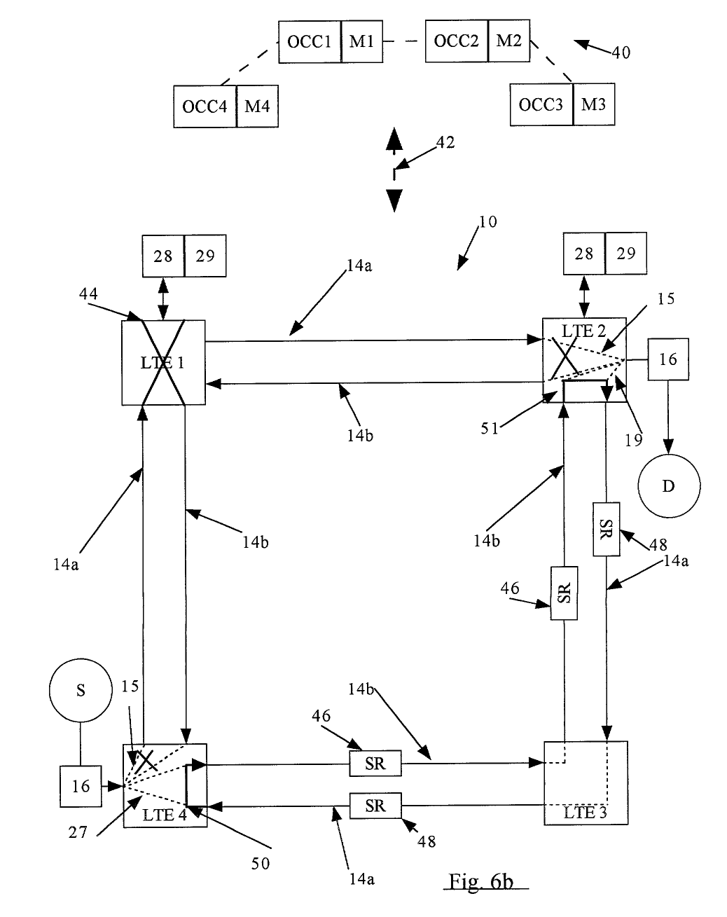

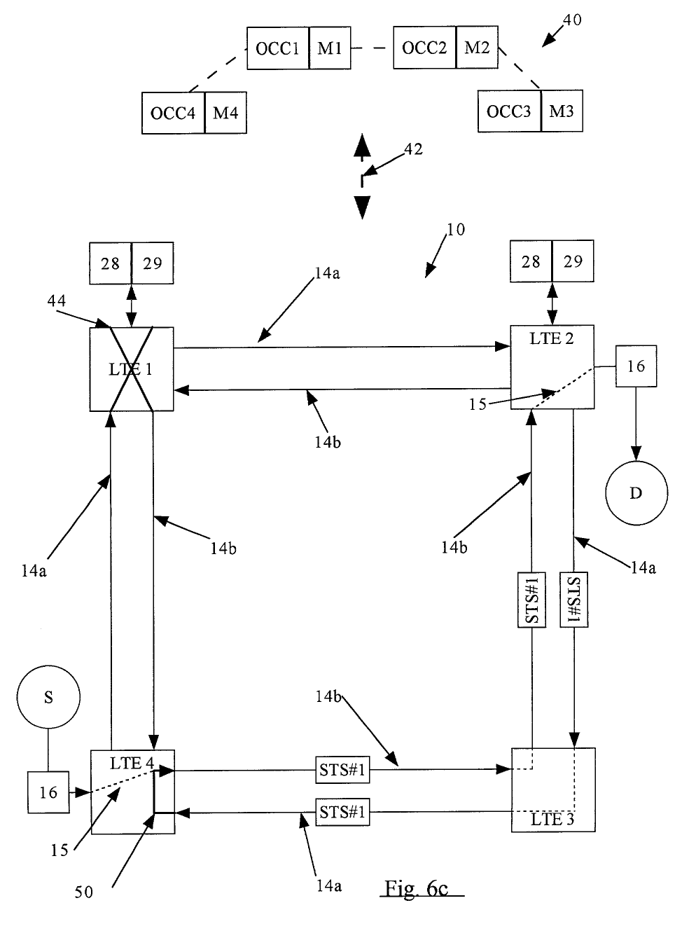

Referring to FIG. 6a, the LTEi of the transport network 10 are monitored by the OCCi in the control plane 40. Communication between the transport network 10 and the control plane 40 is symbolised by the link 42. It should be noted that the traffic 16 pattern is the same as that discussed in relation to the transport network 10 of FIG. 3a, for the sake of convenience. Accordingly, the timeslot interchange of working timeslots STS#1 received from LTE4 to STS#2 transmitted by LTE1 on respective lines 4-1 and 1-2 has been communicated through link 42 to the OCCi of the control plane 40, which can be done by the LTEi or though access of the timeslot interchange modules 28 by the OCCi.

Referring to FIG. 6b, a nodal failure 44 affecting lines 14a,b of lines 4-1 and 1-2 (effectively a multi-line failure of adjacent lines) is detected by the adjacent LTE4 and LTE2 on both their protection/working timeslots. Therefore, the LTE2 becomes one of the switching nodes according to standard BLSR protocols. In the present case, for exemplary purposes only, the LTE4 is regarded as the head-end and the LTE2 as the tail-end for traffic 16 transmitted by element S to element D. Accordingly, LTE2 tries to send a ring switch request 48 to LTE1 along intended path 2-3-4-1. LTE4 receives the switch request 48 performs a working to protection bridge 50 to make available all outgoing traffic 16 on the working timeslots STS#1-24 of LTE1 to the protection timeslots STS#25-48, as redirected to LTE3, as well as updates the respective K2 byte, bits 6-8. However, the reconfiguration of the LTE2 receive switch selection 19 from the internal routing 15 is suspended, pending confirmation by the OCCi (see FIG. 6c), thereby disabling the reception of traffic 16 by the LTE2. This is because LTE4 receives the ring switch request 48, rather than the intended LTE1. It is noted that as LTE2 is the tail-end, it can bridge immediately upon detecting the failure 44.

Similarly, LTE2 will receive a ring switch request 46 from LTE4 when LTE4 acts as the tail-end node, rather than the intended LTE1. Therefore a switch selection 27 of LTE4 when acting as the tail-end node is also suspended pending notification from the OCCi (see FIG. 6b), thereby disabling the switch selection 27. It is also recognized that LTE2 would initiate a bridge 51 when acting as the head-end, while the tail-end LTE4 would rely upon switch selection 27 to receive traffic 16 transmitted by the element D to the element S from the chosen protection timeslots STS#25-48. Accordingly, the effective multi-line failure 44 has been detected by both LTE4 and LTE2, which now must wait for additional instructions from the OCCi to account for any TSI that may have been implemented on the transport network 10 (due to the mismatch of APS IDs). It is noted that LTE3 enters bi-directional full pass-through mode to accommodate the transmission of the ring switch requests 46 and 48. It is further noted that other multi-line failure modes can occur other than that shown in FIG. 6b, such as non-adjacent lines that fragment the transport network 10 into two or more ring subgroups.

In the present example (similar to that associated with FIG. 3b) before the respective switch selection 19 is initiated, the LTE2 tries to confirm the originating APS ID of the ring switch request 46 but notes that the APS ID is not equal to LTE1. Likewise, the LTE4 tries to confirm the originating APS ID of the ring switch request 48, but notes that the APS ID is not equal to LTE1. Therefore, the APS ID comparison modules 29 determine that the APS IDs are not matching, which confirms to the switching nodes LTE4 and LTE2 that the detected failure 44 should be considered as a multiple line failure, affecting lines 4-1 and 1-4. Accordingly, the switching nodes LTE4 and LTE2 could also contact their respective OCC4 and OCC2 through the link 42 to inform them that the multiple line failure 44 has occurred. Alternatively, the OCCi could be monitoring the state of the transport network 10 and therefore deduce the multi-line failure 44 pattern.

In any event, once the effective multiple line failure 44 has been detected, the affected OCCi then refer to their nodal maps Mn to implement a redial of the failed path 4-1-2. Once the redial has occurred, then the LTE4 and LTE2 reroute their traffic 16 over the new working path 4-3-2, such that the point of failure 44 is avoided. It is recognized that one possible method for redial is to re-apply the same mechanisms, which initially configured the end to end connection between the elements S and D. In any event, the connections of the new working path will reserve their own protection bandwidth capacity, and transmission of the traffic 16 from element S to element D is permitted on the new working timeslots. Referring to FIG. 6c, the redialed connection could be set up on timeslot STS#1 along the available path 4-3-2 until further notice. Accordingly, the ring switched transport network 10 of FIG. 6c has reached the steady state. Therefore, the traffic 16 is now directed from source element S by the internal routing 15 onto the transport network 10, which then transmits the traffic 16 along line 4-3 on the working timeslot STS#1, transmitted by LTE4, then along line 3-2 on the working timeslot STS#1, transmitted by LTE3, and then off the transport network 10 through switch selection 19 to the destination element D. It is recognized that the switch selection 19 similar to the transport network 10 of FIG. 3d could also be implemented for the transport network 10 of FIG. 6b, to accommodate traffic 16 transmitted by the element D to the element S. It is further recognised that timeslot interchange could be employed to optimise the set-up of the redialed connection, if desired.

Once the nodal failure 44 is corrected, it is determined utilizing appropriate BLSR protocols whether to resume the transmission along original path 4-1-2 on the original working timeslots, STS#1 received by LTE1 and STS#2 transmitted by LTE1, if appropriate. The interchange modules 28 would then be updated to reflect the resumption of the transport network 10 to the idle state.

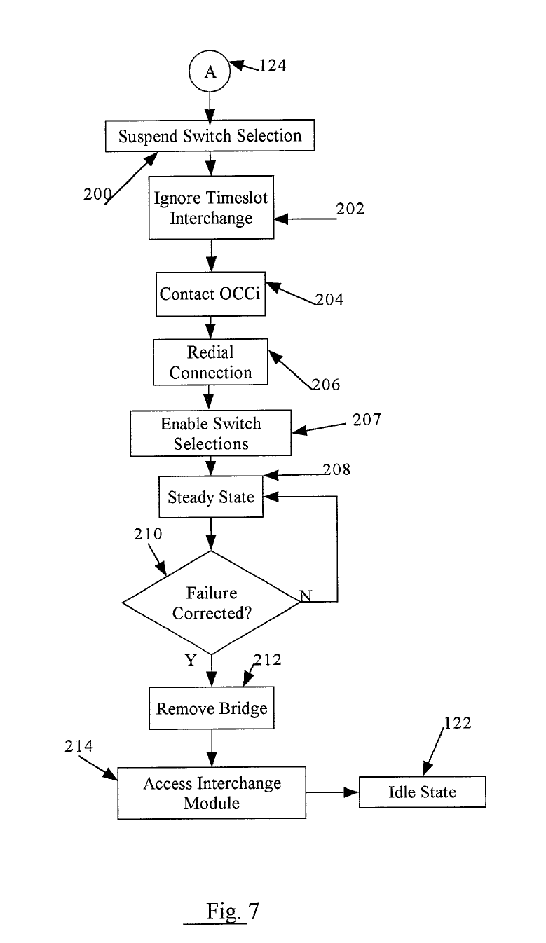

Operation of the ring bridge procedure for the transport network 10 of FIGS. 6a,b,c begins when the multiple line failure 44 is detected at step 104 of FIG. 4, which is connected to the step 124 of FIG. 7. Accordingly, the sending of ring switch requests 46, 48 by the LTE4 and LTE2 to one another (see FIG. 6b) has been done at step 102 of FIG. 4, as well as confirmation through the comparison modules 29 that non-matching APS IDs are present at step 104 of FIG. 4. Therefore, the switch selections 19, 27 are suspended 200 at the respective LTE2 and LTE4 pending further notification from the OCCi. Any timeslot interchanges recorded by the interchange modules 28 pertaining to the failed path 4-1-2 are subsequently ignored 202 for the redialed connection. Instead, the routing algorithm used to reroute the connection applies any desired TSI, based on available bandwidth, and the TSI modules 28 are updated accordingly.

The switching nodes LTE4, LTE2 then contact 204 their respective OCCi to inform them that the multiple line failure 44 has been detected. It is recognized that the LTEi could inform the OCCi that their switch requests 46,48 have not been completed. The trigger of the redial can occur as a result of any switch requests 46,48 which fail to complete. This logic can be applied in general. So in one embodiment, the LTEi just do not switch unless the switch requests 46,48 are destined to the LTEi switching nodes adjacent to the failure 44. It is envisioned that confirmation by the comparison modules 29 of a mismatch in APS IDs could be one example mechanism by which the switch requests 46,48 are ignored by the remote LTEi. This failure to switch will be informed to the OCCi, which can reroute affected connections. Accordingly, the affected OCCi then seek to redial 206 the failed path 4-1-2 by referring to their nodal maps Mn (which contain the topology database) and adjacent OCCi for appropriate available protection timeslots and pathways, and then applying selected routing algorithms to effect the connection reroute. It is noted that the redial process can be end-to-end across the entire network, such that the redialed connection may not even be on the same ring of the transport network 10 as where the failure 44 had occurred.

In the case where protection timeslots have been established in the redialed connection through the affected LTEi, the switch selection 19 is enabled 207 at the LTE2 and LTE4 (see FIG. 6c) and the transport network 10 reaches a steady state 208. It is recognized that if the redialed connection is on a different set of working timeslots, then the enablement of the switch selection 19 is not applicable.

In the event the redialed pathway uses the switch selections 19 and the bridge 50, once the failure 44 has been corrected 210, the bridge 50 and the switch selections 19 are removed 212, according to BLSR protocols so that collisions are avoided, and the traffic 16 can resume transmission along the original path 4-1-2 from the source element S to the destination element D, if appropriate (see FIG. 6a). The interchange modules 28 are updated 214 by the OCCi to reflect the resumed working timeslot configuration for present timeslot interchanges. Therefore, the transport network 10 is returned to its idle state at step 122. It is recognised that the interchange module 28 can be accessed by the LTE4 prior to bridge 50 removal, so as to confirm that the employed working timeslot STS#1 transmitted by LTE4 on path 4-3-2 should be placed back onto the working timeslot STS#1 transmitted by LTE4 for the path 4-1-2.

An alternative to the above, it may not be necessary to return the traffic 16 to its original pathway 4-1-2 once the failure 44 has been corrected. In particular, the redial process may be a completely separate mechanism for the restoration/protection, on the transport network 10, to accommodate multiple line failures 44. In addition, it is recognized in the above example transport network 10 that a 4-fibre BLSR could be employed. Accordingly, in the case of a complete span failure of all fibres between two adjacent LTEi, the ring switching protection scheme could be used to redirect the traffic 16, for example, from a selected working timeslot STS#1 to a selected protection timeslot STS#1, as full bandwidth capacity OC-N is used for both protection and working fibres. Similarly, the above-described ring switching scheme could also be adapted for single nodal failures on 4-fibre BLSR. It is also recognized that other OC port sizes could be used for the LTEi other than OC-48. Further, different port sizes could be employed on different lines when TSI is used in the transport network 10, since the SONET BLSR constraint that each routed connection must occupy the same STS time slot within a BLSR ring is removed. Accordingly, it is recognized that the use of TSI helps to allow the use of different port sizes on the same BLSR ring of the transport network 10, both on the working and protection timeslots.

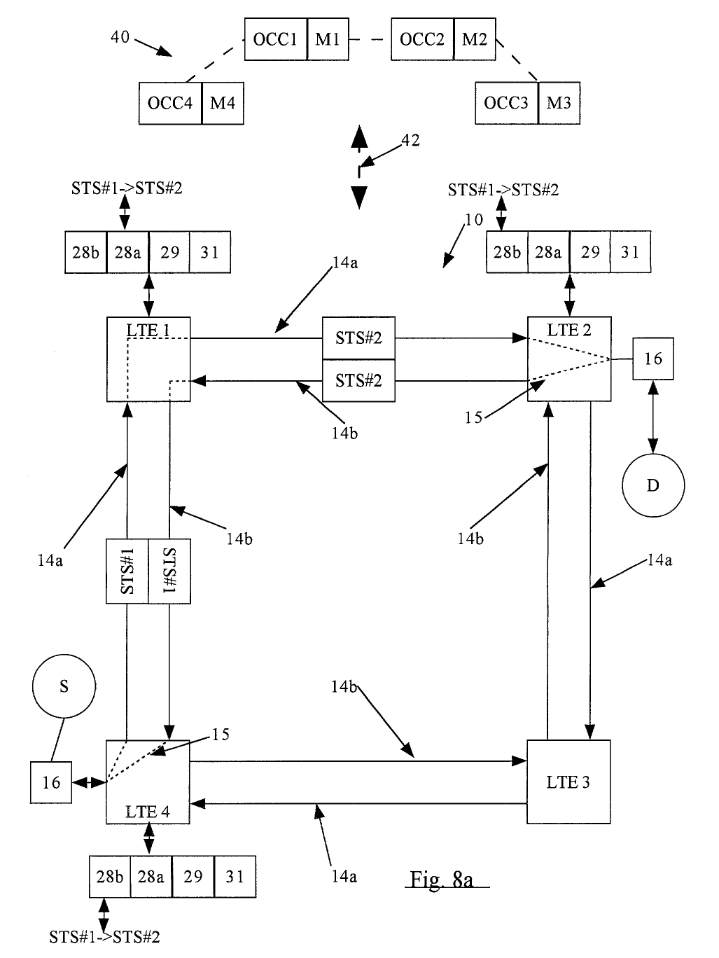

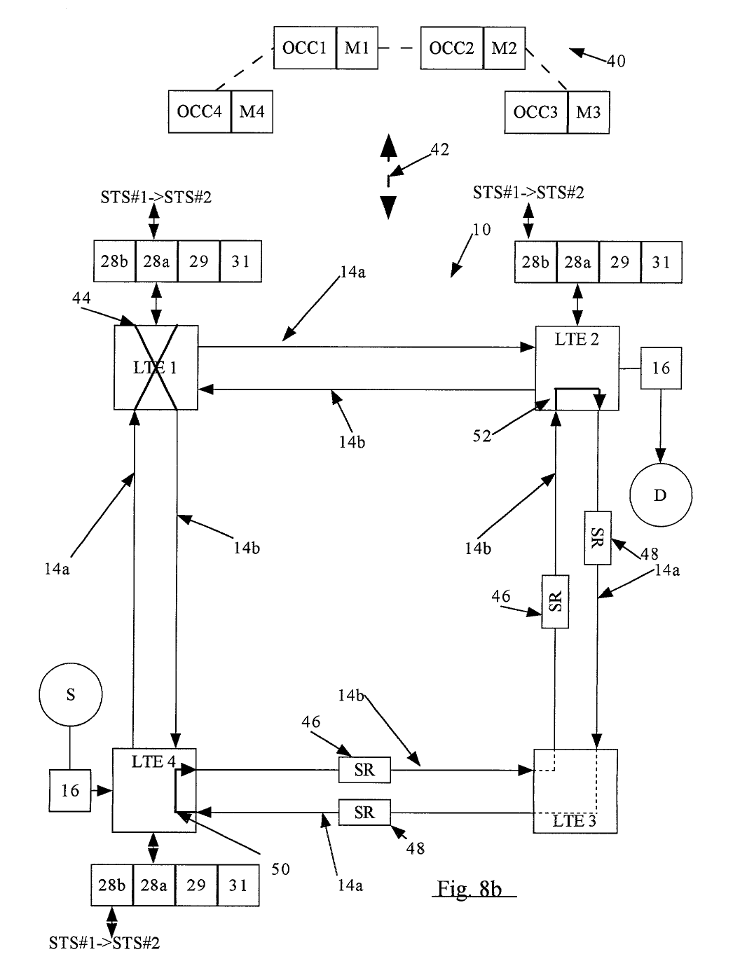

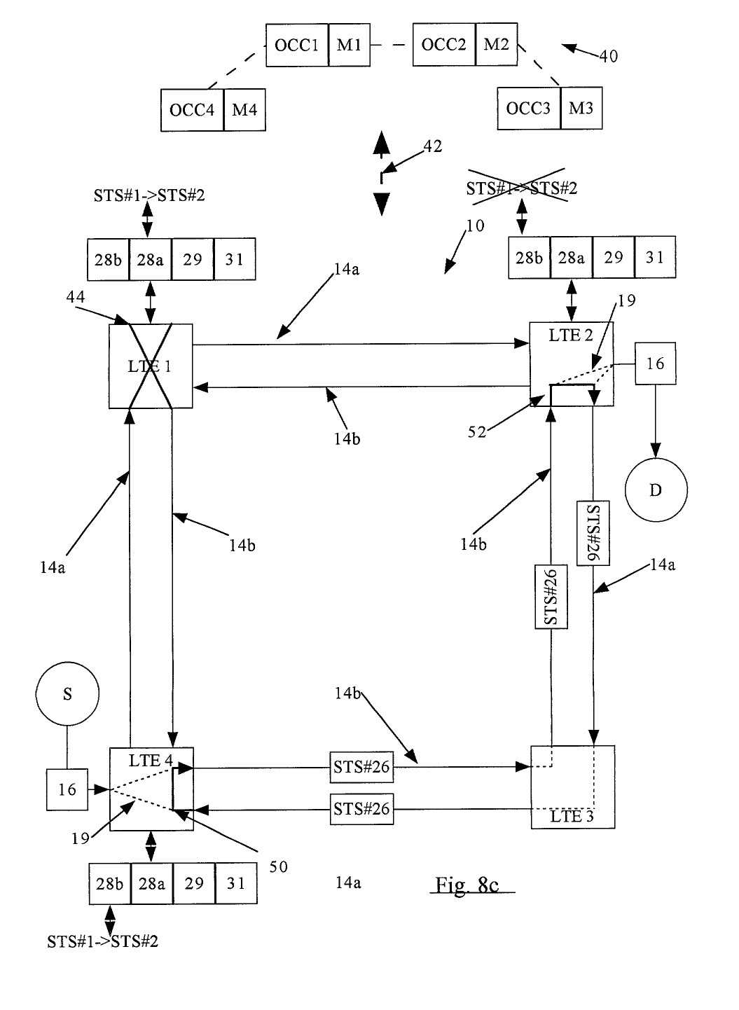

Referring to FIG. 8a, another embodiment of the present ring switching protection scheme is given. The presented connection pattern is similar to that of FIG. 6a. However, the interchange modules 28 are now represented such as but not limited to by 28a and 28b, therefore providing multiple versions or maps of the individual connections for each of the LTEi on the transport network 10. It is recognized that more that two versions of the modules 28 can be used, if desired. It is further recognized that the TSI information of modules 28a,b could be documented by a single module 28 partitioned for two or more sets of TSI information. Accordingly, each interchange module 28a would be responsible for recording the TSI information only used directly by the respective LTEi in carrying out their pass-through timeslot interchange. Therefore, the modules 28a of LTE4 and LTE2 would contain one-to-one connection mapping, but the module 28a of LTE1 would contain the recorded STS#1/STS#2 time slot interchange between lines 4-1 and 1-2. However, the interchange modules 28b would be responsible for recording the TSI implemented by other LTEi on the transport network 10, such as the modules 28b of LTE2 and LTE4 would contain the TSI information implemented by LTE1, i.e. the STS#1/STS#2 interchange. In this example, the module 28b of LTE1 would contain one-to-one mapping. The creation of these multiple versions of the interchange modules 28a,b would be updated by either the OCCi and/or the LTEi, when the particular pathways and timeslots are setup to process the traffic connection requests 21. Further, these multiple modules 28a,b would be updated when pathways of the transport network are changed, such as but not limited to redialing of connections and restoration after the detected network failure has been corrected. In the event the LTEi modules 28 do not contain the required routing information to respond to a particular failure configuration, the responsibility for implementing an appropriate protection pathway would be passed off to the control plane 40.

Referring to FIG. 8b, the nodal failure 44 is detected by both the LTE4 and LTE2, since the APS IDs do not match for the switch requests 46, 48, similar to that as described above with reference to FIG. 6b, i.e. APS IDs are checked by the comparison modules 29. Further, the transport network of FIG. 8b shows the bridge 50, which is not initiated until the internal routing 15 at the LTE2 (see FIG. 8a) have been suspended, hence placing LTE2 in an idle state. Similarly, a bridge 52 at the LTE2 is not implemented until the internal routing 15 at the LTE4 has been suspended, hence placing the LTE4 in an idle state. This extra handshaking can be facilitated through the ring switch requests 46, 48. Accordingly, once the LTE4 has determined that the APS ID of the ring switch request 48 is not equal to LTE1, rather ID=LTE2, the LTE4 requests confirmation from the LTE2 that its respective internal routing 15 has been suspended. Once confirmed, the LTE4 executes the ring bridge 50. Similarly, the LTE2 first confirms that the LTE4 has disabled its internal routing 15 before executing the ring bridge 52. This confirmation procedure helps to avoid misconnections occurring with the traffic 16 in transit, before the required bridges 50, 52 and switch selections 19 (see FIG. 8c) can be established in response to the detected failure 44. Once established, the receive switch selections 19 facilitate the communication of traffic 16 between the source and destination elements S, D.

It is envisioned with respect to the above bridge/switch procedure that the confirmation is done before the switch operation. Before completing the switch selection 19 at the tail-end, the bridged traffic 16 is checked to see which node is at the far head-end. By performing this check via the comparison module 29, the present failure scenario is determined and the appropriate maps contained in the respective TSI modules 28a,b can be used to implement the appropriate ring switch for the detected failure scenario. Accordingly, there could be only one type of ring bridge per side per ring ADM. At the onset of LTE1, neither LTE2 nor LTE4 knows whether the failure scenario is one in which a respective LTEi is isolated. However, they do not always need to know the type of failure mode to perform their respective bridges, as the bridge can be done irrespective of whether the LTE4 is seeing just a single line failure between LTE1 to LTE4 or whether it is actually an effective multi-line failure. It is noted that if the given failure scenario is one in which appropriate TSI maps 28a,b are not available, then the ring switch may not be completed with the expected TSI pass-through conditions. Accordingly, the failure to complete the ring switch can sent to, or detected by, the OCCi such that the connections affected by the failure 44 can be redialled through the control plane 40.

As such, the bridging of traffic 16 destined from LTE4 to LTE1 the other way around the ring of the transport network 10 on the protection timeslots can occur prior to any confirmation as such. This provides for the implementation of the present protection ring switching scheme with minimized changes to current BLSR signaling, as the current signaling behaviour calls for an immediate bridge upon detection of the signal condition.

During the handshaking procedure to determine between the LTE4 and LTE2 when the bridges 50, 52 should be executed, either LTE4 or LTE2 confirms according to a precedence protocol that one of them should perform the TSI of STS#1/STS#2 prior to transferring the traffic 16 capability across the respective bridges 50, 52. This precedence protocol could be: based on the nodal identification procedure through the comparison modules 29; part of the ring bridge requests 46, 48; or could be recorded in the interchange modules 28a,b as to which LTEi takes precedence in the event of a failure, for a specific LTEi or multiple connection failure adjacent to the specific LTEi (i.e. effective multi-line failure). For example, referring to FIG. 8c, the LTE4 now changes its TSI module 28a to 28b by using a selection module 31, while the LTE2 retains the use of its module 28a by its selection module 31 in order to respond to the confirmed effective multi-line failure 44. It should be noted that the selection module 31 decides between interchange modules 28a,b for a particular LTEi, based on the APS IDs identified and the precedence protocol used. The LTE4 has been chosen as the LTEi to implement the TSI recorded in its interchange module 28b, indicated by the TSI of LTE2 being ignored at arrow 46. The switch selections 19 have also now been enabled after the bridges 50, 52 were executed. Accordingly, the traffic 16 is timeslot interchanged from working timeslot STS#1 to working timeslot STS#2 by the LTE4, prior to being bridged onto protection timeslot STS#26 by the bridge 50. Therefore, the LTE2 ignores the TSI information in its interchange module 28b and simply bridges and selects the traffic 16 from the protection timeslot STS#26, thereby matching the protection timeslot established on the pathway 4-3-2 by LTE4.

Alternative to the above, the above described precedence protocol can be removed, such that the required TSI can still be determined. Accordingly, all the TSI used to absorb the TSI of missing/failed pass through LTEi is handled by the receiving end. In the example of LTE4 switching with LTE2, then as typically we are dealing with bi-directional traffic 16, the TSI will be handled simultaneously by the switching nodes: LTE4 at its receive switch TSI module 28a,b (receiving direction only) and by LTE2 in its receive switch TSI module 28a,b (receiving direction). Once again, the bridge (transmit direction) is always using the same TSI module 28a,b for an east ring switch and a west ring switch.

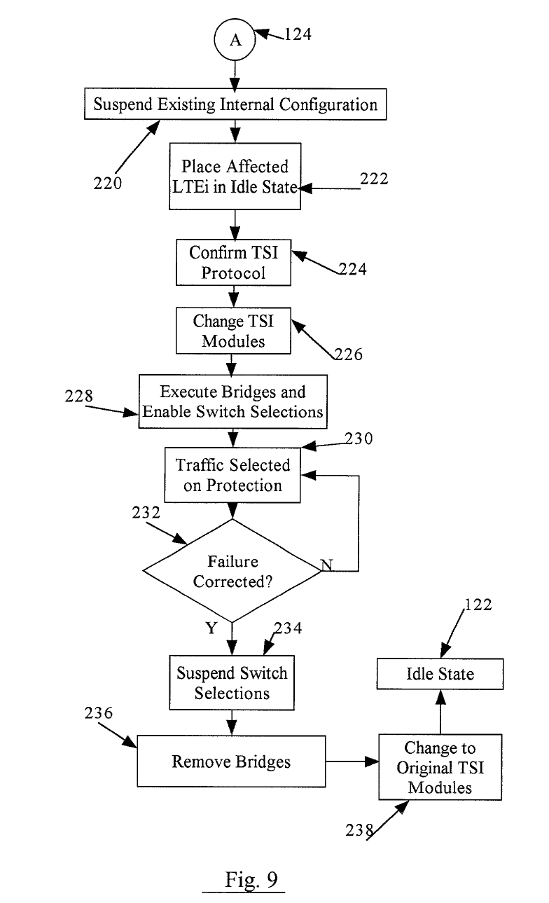

Referring to FIG. 9, the failure example of FIGS. 8a,b,c is described. Initially, the effective multi-line failure 44 is confirmed at step 124 (stemming from the decision 104 of FIG. 4). However, the difference is that the execution is delayed for the bridges 50, 52 and switch selections 15, so as to discourage potential misconnections. Accordingly, after the failure 44 detection, the existing internal routings 15 (see FIG. 8a) are removed 220 from the LTE2, LTE4, which places them in the idle state 222. The LTE2 and LTE4 then confirm 224 the choice of TSI modules 28a,b to use based on the identification of the failed components of the transport network 10. In the present example, the LTE2 retains the TSI module 28a and the LTE4 changes from module 28a to 28b at step 226. The bridges 50, 52 (see FIG. 8b) and then the switch selections 19 (see FIG. 8c) are then established 228 so that potential misconnections are discouraged. The switch selections 19 are for choosing the traffic 16 from either the working timeslots or the protection timeslots at the tail-end LTEi. The traffic 16 is then transmitted and selected 230 on the mutually established protection timeslot STS#26 for the pathway 4-3-2, thereby placing the transport network 10 in the steady state. This operation continues until the failure 44 is corrected at step 232.

Accordingly, the switch selections 19 are then disabled 234, then the bridges 50, 52 are removed 236 so that potential misconnections are discouraged. The LTE2 and the LTE4 then revert to their original TSI modules 28a and the transport network 10 resumes the idle state 122 as given by the connection configuration of FIG. 8a, whereby the original internal routings 15 are reestablished to facilitate the pass-through communication of the traffic 16 by the LTEi on the transport network 10. The transmission of the traffic 16 then resumes between elements S and D.

It is recognised in the above that with the introduction of TSI in the pass-through connections, this TSI must be replaced should that respective LTEi implementing the TSI either fails, or is isolated from the rest of the LTEi on the transport network 10. One method is to store at each LTEi the pass-through TSI of neighbouring LTEi, in the respective TSI modules 28b. Alternatively, the application of the pass-through TSI need not be computed and applied once the failure is detected. Instead, all of this computation can be performed upfront by the OCCi when the end-to-end connection between the source S and destination D elements is set up. This computed TSI can then be downloaded into the LTEi prior to any switch request occurring in response to the detected failure 44.

Continuing with the example of the TSI modules 28a,b shown above, other TSI connection modules 28a,b could be used to recover from the example failure scenarios of 1) east ring switch with east neighbour node missing, and 2) west ring switch with west neighbour node missing. As such, the following example set of maps along with the TSI modules 28a,b would be used to recover from such detected failure conditions;

idle map,

west side of LTE span switch map,

east side of LTS span switch map,

west & east both span switched map,

TSI module 28a,b for west ring switch single link failure only,

TSI module 28a,b for east ring switch single link failure only,

TSI module 28a,b for west ring switch with east neighbour node missing (Note this is an Rx map as the ring bridge (Tx map) can be performed independently of the scenario hence the Tx map can be shared with that for the single link failure), and

TSI module 28a,b east ring switch with west neighbour node missing (Note this can be half a map as the ring bridge can be performed independently of the scenario hence the Tx map can be shared with that for the single link failure).

Further, it is envisioned that this list of maps and corresponding TSI modules 28a,b could be extended to cover additional failure scenarios in which additional LTEi are lost on the transport network 10. For example, two nodes lost to the east. The TSI module 28a,b versions need only be applied as appropriate to a given failure scenario. It is recognised if an appropriate version of the TSI modules 28a,b is not available to cover the detected failure scenario, the OCCi can become involved to perform a redial of the connection between the source and destination elements S,D.

In the above-described embodiment, it is recognized that additional versions of the TSI modules 28a,b could be employed to account for more complex examples of line/nodal failures, such that the above described tear down and reestablishment sequences can be adapted to discourage misconnections. Further, it is also recognized that multiple sets of the TSI modules can be accessible by each respective LTEi, in the case where the LTEi are operated as matching nodes between adjacent and distinct ring transport networks 10. Further, the maps Mi of the OCCi could share their contents with the interchange modules 28a,b of the LTEi to be used as a backup, or to provide additional network 10 configuration information to the modules 28a,b. The exchange or sharing of network information and TSI between the maps Mi and the modules 28a,b could be coordinated by the LTEi and/or the OCCi involved. Further, the computer readable medium 26 could be used to program the OCCi and/or the LTEi operation to help facilitate the implementation of TSI and failure detection/correction protocols on the transport network 10. Further, the modules 28, 29, 31 could be implemented as hardware, software, or a combination thereof.

Although the invention has been described with reference to certain specific embodiments, various modifications thereof will be apparent to those skilled in the art without departing from the spirit and scope of the invention as outlined in the claims appended hereto.

1. In a line switched ring network, a network element for providing a ring switching protection scheme in a timeslot interchange environment, the network element comprising:
a) a link for connecting the network element to a transport network;
b) a comparison module accessible by the network element, the comparison module adapted to confirm a nodal identity of a switch request receivable by the network element from other network elements on the transport network;
c) a timeslot interchange module accessible by the network element, the interchange module adapted to document a timeslot interchange when performed by the network element between adjacent spans of the transport network;
wherein the network element is adapted to enable the timeslot interchange, based on the confirmed nodal identity, in association with a ring bridge for bridging between working and protection timeslots in the event of a network failure.

2. The network element according to claim 1, wherein the interchange module is locally accessible in the transport network.

3. The network element according to claim 2 further comprising a second link for monitoring the documented contents of the interchange module by a control element.

4. The network element according to claim 2, wherein the interchange module is adapted to document timeslot interchange information specific to the time slot interchange when performed by the network element.

5. The network element according to claim 4 further comprising a second time slot interchange module accessible by the network element, the second interchange module for documenting timeslot interchange information specific to the time slot interchange when performed by a second network element in the transport network.

6. The network element according to claim 5 further comprising a selection module for selecting one interchange module from the pair of interchange modules for accessing the corresponding documented timeslot interchange information therein.

7. The network element according to claim 6, wherein the selection between the pair of interchange modules by the selection module is based on a predefined precedence protocol.

8. The network element according to claim 5, wherein the two sets of timeslot interchange information is adapted to document on separate partitions common to one of the interchange modules.

9. The network element according to claim 2, wherein the interchange module is adapted to assign different timeslot utilisation for the adjacent spans of the transport network.

10. The network element according to claim 9, wherein the different time slot utilisation is adapted to inhibit stranded bandwidth on the transport network.

11. The network element according to claim 10, wherein the interchange module is adapted to document the timeslot interchange performed between a pair of working timeslots.

12. The network element according to claim 9 further comprising a second link for monitoring the contents of the interchange module by a control element

13. The network element according to claim 12, wherein the second link is adapted to permit the control element to monitor the documentation of the timeslot interchange information by the interchange module.

14. The network element according to claim 4, wherein the network failure is a single span failure for precipitating the switch request.

15. The network element according to claim 6, wherein the network failure is an effective multiple span failure for precipitating the selection between the pair of interchange modules by the selection module.

16. In a line switched ring network, a computer program product for providing a ring switching protection scheme in a timeslot interchange environment, the product comprising:
a) a computer readable medium;
b) a link module stored on the computer readable medium for connecting the network element to a transport network;
c) a comparison module coupled to the link module, the comparison module accessible by a network element, the comparison module confirming a nodal identity of a switch request when received by the network element from other network elements on a transport network.
d) a time slot interchange module coupled to the comparison module, the interchange module accessible by the network element, the interchange module for documenting a time slot interchange when performed by the network element between adjacent spans of the transport network;
wherein the computer program product enables the timeslot interchange, based on the confirmed nodal identity, in association with a ring bridge performed by the network element for bridging between working and protection timeslots in the event of a network failure.

17. The computer program product according to claim 16, wherein the interchange module is locally accessible in the transport network.

18. The computer program product according to claim 17 further comprising a second link module stored on the computer readable medium for monitoring the documented contents of the interchange module by a control element.

19. The computer program product according to claim 17, wherein the interchange module is adapted to document timeslot interchange information specific to the timeslot interchange when performed by the network element.

20. The computer program product according to claim 19 further comprising a second timeslot interchange module coupled to the comparison module accessible by the network element, the second interchange module for documenting time slot interchange information specific to the timeslot interchange when performed by a second network element in the transport network.

21. The computer program product according to claim 20 further comprising a selection module stored on the computer readable medium for selecting one interchange module from the pair of interchange modules for performing the corresponding documented timeslot interchange information therein.

22. The computer program product according to claim 20, wherein the two sets of timeslot interchange information are documented on separate partitions common to one of the interchange modules.

23. The computer program product according to claim 17, wherein the interchange module is adapted to assign different timeslot utilisation for the adjacent spans of the transport network.

24. The computer program product according to claim 23, wherein the different timeslot utilisation is adapted to inhibit stranded bandwidth on the transport network.

25. The computer program product according to claim 24, wherein the interchange module is adapted to document the timeslot interchange performed between a pair of working timeslots.

26. The computer program product according to claim 23 further comprising a second link module stored on the computer readable medium for monitoring the contents of the interchange module by a control element.

27. The computer program product according to claim 26, wherein the second link module is adapted to permit the control element to monitor the documentation of the timeslot interchange information by the interchange module.

28. The computer program product according to claim 21, wherein the network failure is an effective multispan failure for precipitating the selection between the pair of interchange modules by the selection module.

29. In a line switched ring network, a method for providing a ring switching protection scheme in a timeslot interchange environment, the method comprising the steps of:
a) detecting a network failure by a first network element adjacent to the failure;
b) transmitting a switch request by the first element to a corresponding second network element adjacent to the failure and opposite to the first element;
c) comparing a nodal identity of the switch request when received; and
d) performing a timeslot interchange in response to the nodal identity comparison, in association with a ring bridge performed for bridging between working and protection timeslots in the response to the failure.
